(19) United States
(12) Patent Application Publication
(10) Pub. No.: US 2003/0114955 A1
(43) Pub. Date: Jun. 19, 2003

(54) Method and system for processing return to sender mailpieces, notifying sender of addressee changes and charging sender for processing of return to sender mailpieces

(75) Inventor: Edward P. Daniels JR., Trumbull, CT (US)

Correspondence Address: PITNEY BOWES INC., 35 WATERVIEW DRIVE, P.O. BOX 3000, MSC 26-22, SHELTON, CT, 06484-8000, US

(73) Assignee: Pitney Bowes Incorporated, Stamford, CT

(21) Appl. No.: 10/022,975

(22) Filed: Dec. 17, 2001

(51) Int. Cl. G06F 7/00

(52) U.S. Cl. 700/224; 700/223; 700/219

(57) ABSTRACT

An embodiment of the system of the present invention comprises a mailpiece sorting apparatus, a label printer, a graphical user interface, address cleansing database, corrected address database, sender computer system, sender database and a web server for interconnecting several components of the system. The system provides a closed loop solution for reducing potential return to sender outgoing mailpieces prepared by a sender that is receiving incoming sorting incoming mailpieces sorted by the incoming mailpiece sorting apparatus. The system includes user screens including data input screens and report screens. Because of the significant expense in processing return to sender mailpieces the system of the present invention tracks and calculate statistical information and cost information regarding the return to sender mailpieces so that the sender can be charged for the cost of sorting return to sender mailpieces.

### FIELD OF THE INVENTION

The invention disclosed herein relates generally to automated mail sorting and more particularly, method and system for processing return to sender mail and reducing the amount of subsequent return to sender mail created by the sender.

### BACKGROUND OF THE INVENTION

The processing and handling of mailpieces consumes an enormous amount of human and financial resources, particularly if the processing of the mailpieces is done manually. The processing and handling of mailpieces not only takes place at the Postal Service, but also occurs at each and every business or other site where communication via the mail delivery system is utilized. That is, various pieces of mail generated by a plurality of departments and individuals within a company need to be addressed, collected, sorted and franked as part of the outgoing mail process. Additionally, incoming mail needs to be collected and sorted efficiently to ensure that it gets to the addressee (i.e. employee or department) in a minimal amount of time. Since much of the documentation and information being conveyed through the mail system is critical in nature relative to the success of a business, it is imperative that the processing and handling of both the incoming and outgoing mailpieces be done efficiently and reliably so as not to negatively impact the functioning of the business.

Various automated mail-handling machines have been developed for processing incoming mail (removing individual pieces of mail from a stack and performing subsequent actions on each individual piece of mail). Generally, the mail handling machines separate individual mailpieces from a stack, read the mailpieces using an optical character recognition (OCR) system and compare the read information to an addressee database in order to determine the appropriate destination points for delivery of the mailpieces. Some of the incoming mail received at a mailroom of the company can be unreadable by the OCR system, the quantity of which can be great since recipients cannot control the addressee format in which the incoming mail is received. Some of the unreadable mail could be, for example, mail which is not OCR readable called OCR rejects (i.e. smeared or needs to be opened to determine addressee), mystery mail which mail with no particular addressee (i.e. mail addressed to a company or department only or mail with poor quality handwriting), or research mail (i.e. mail that can not be read by OCR but does not require opening for the operator to determine the addressee, including the situation where there are several potential addressees with the same name). The unreadable mail, which will be referred to generally as reject mail is expensive to process since it drains the resources of the mail room requiring additional time and labor for sorting and delivery.

another type of mail, which can be categorized as unreadable, generally by incoming mail sorting apparatus is return to sender (RTS) since the addressee, in most cases, is not in the addressee database of the mail sorting apparatus. Typical return to sender mail is marked with return to sender text and/or a graphics symbol. The graphics symbols applied to return to sender mail are not uniform or standard and are not applied to a standard location on return to sender mailpieces. An OCR system configured to recognize text could be configured with additional capabilities and additional read regions to recognize return to sender icon or markings. Other methods could also be used to determine return to sender mail such as reading the addressee ZIP Code, if it is readable to determine if the addressee is in the addressee database.

An easier and possibly less costly method of handling the challenges of return to sender mail is to reduce it at its source—the company where the mailing is produced. The reduction of return to sender mail by obtaining more accurate address information at it's source is important for many reasons including reducing overhead costs in sorting and delivering mailpieces, but also in managing customer relationships. Each year, corporations spend billions of dollars on customer relationship management (CRM). One of the biggest challenges businesses face is preventing inaccurate data from compromising their databases. As Web based interactions become more prevalent, customers become more remote and interactions with customers become impersonal. Customer relationship management becomes more important. As businesses capitalize on making sales to existing customers, it becomes increasingly important to have up to date customer information including address information in the business database, which is an important asset. Accurate data is the cornerstone of any customer relationship management strategy. A corporation cannot build a relationship or properly serve or sell to customers if it does not know where they are. Companies routinely face the challenge of keeping data accurate in a world that is constantly changing.

Any CRM strategy that fails to recognize the dynamic nature of consumers' lives and lifestyles is likely to fall short of expectations. The dynamic lives and lifestyles of American's are evident in the fact that the average American moves about once every five years. In fact, 17 percent of Americans move every year. Of the people who move annually, 40 percent of them do not notify the USPS of their new address. Furthermore, even when they do not move, consumers are not stagnant; they get married, buy homes, get promotions, switch jobs, etc. They essentially become lost customers to many companies. For high-volume mailers, the consequences include missed cash flow and costly mail rework.

To compete in our data centric world, businesses need to ensure data integrity and accuracy. But how do you get accurate customer data? Companies need to append missing information or correct inaccurate information to complete the portrait of their customer and feed that data to the various operational units that need it—including call centers, marketing groups and the sales force. A business with this capability has an edge because of its enhanced ability to communicate with its customers and—by keeping the solution in-house—by maintaining customer confidentiality. Clean data allows for more true one-to-one marketing, improved response rates, reduced costs due to inaccuracies, and perhaps most important of all, security from fraud.

And more to the point, how do companies utilize customer data effectively, particularly when the data is located in disparate repositories spread across a global business enterprise? Businesses need to recognize and interconnect the components of document management. Five components of document management are create, produce, distribute, receive and update. And an infrastructure is needed to connect these components to reducing end-to-end costs, increase user convenience and ensure delivery reliability and security.

Thus, one of the problems of the prior art is that a system is not available for to provide a closed loop solution for processing return to sender mail and improving data inaccuracies and connect components of customer relationship management. Therefore, a system and method for processing return to sender mailpieces is needed which integrates return to sender processing with the incoming mailpiece sorting apparatus and with sender data for improving accuracy of sender data for future mailings. Additionally a method is needed for charging the sender the cost of processing such return to sender mailpieces.

### SUMMARY OF THE INVENTION

This invention overcomes the disadvantages of the prior art by providing a method of processing return to sender mailpieces and providing updated data to sender(s) for preparation of future mailpieces. This in turn helps to solve data quality problems at their source and reduce processing costs by reducing the number of subsequent return to sender mailpieces. The present invention is directed to, in general, automated mail sorting and more particularly, a method of reducing return to sender mail using an automated mailpiece sorting apparatus and a commercially available address cleansing database to provide closed loop processing.

An embodiment of the system 200 of the present invention comprises a mailpiece sorting apparatus 8, a label printer 74, a graphical user interface 102a, address cleansing database 70, corrected address database 71, sender computer system 85, sender database 85a and a web server 80 for interconnecting several components of the system 200. The system 200 provides a closed loop solution for reducing potential return to sender outgoing mailpieces prepared by a sender that is receiving incoming sorting incoming mailpieces sorted by the incoming mailpiece sorting apparatus 8.

In an embodiment of the method of the present invention, mailpieces are sorted by the mailpiece sorting apparatus. Mailpieces that can be read properly by the mailpiece sorting apparatus are sent to their designated sort bins. Mailpieces that the mailpiece sorting apparatus determines to be return to sender mailpieces are sent to a return to sender bin. The return to sender mailpieces are processed using a graphical user interface processing software applications and address cleansing database 71 and/or corrected address database 70. Cleansed address information and other messages are sent from the system 200 to the corrected address database 70 and/or sender 85. The cleansed and other address information is used to either out sort mailpieces from the outgoing mail stream or correct address information for outgoing mailpieces. It is also used to correct the sender's database 85a. The method of the present invention can be used to collect information to generate reports and statistical information regarding return to sender mail handling costs.

An advantage of the method of the present invention is that it provides a document management solution by providing a system and method to receive and update the mailpiece creation and delivery process. Another advantage of the present invention is that it reduces end-to-end costs, increases user convenience and improves delivery reliability and security. Other advantages of the invention will in part be obvious and will in part be apparent from the specification. The aforementioned advantages are illustrative of the advantages of the various embodiments of the present invention.

### DESCRIPTION OF THE DRAWINGS

The above and other objects and advantages of the present invention will be apparent upon consideration of the following detailed description, taken in conjunction with accompanying drawings, in which like reference characters refer to like parts throughout, and in which:

FIG. 1 is a block diagram that illustrates a computer system with which an embodiment of the invention may be implemented;

FIG. 2a illustrates the connection of the computer system to a sorting apparatus;

FIG. 2b is a block diagram illustrating an eight bin module which may be part of the mailpiece sorting apparatus which is used to perform an embodiment of the of the present invention;

FIGS. 3a-3d illustrate various reject mailpieces;

FIGS. 4a-b illustrates exemplary return to sender mailpieces;

FIG. 5 is a block diagram schematic of an embodiment of the apparatus of the present invention; and

FIG. 6 is a flowchart of an embodiment of the method of the present invention for processing return to sender mailpieces.

FIGS. 7a-f illustrate embodiments of user screens from the graphical user interface of the system of the present invention including data input screens and report screens.

### DETAILED DESCRIPTION OF THE PRESENT INVENTION

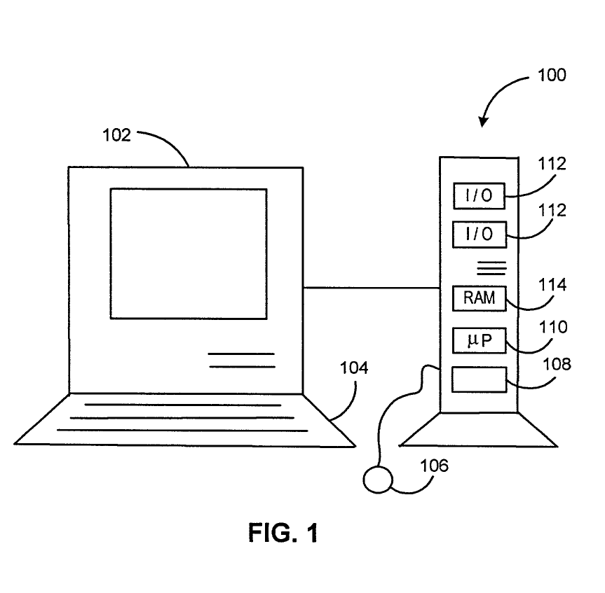

In describing the present invention, reference will be made herein to FIGS. 1-6 of the drawings in which like numerals refer to like features of the invention. Features of the invention are not necessarily shown to scale in the drawings.

Control and Mail Sorting Apparatus Overview

FIG. 1 is a block diagram that illustrates a computer system 100, the use of which an embodiment of the invention may be implemented. Computer system 100 may be a personal computer which is used generically and refers to present and future microprocessing systems with at least one processor operatively coupled to user interface means, such as a monitor 102 and keyboard 104, and/or a cursor control, such as a mouse or a trackball 106, and storage media 108. The personal computer 100 may be a workstation that is accessible by more than one user. The personal computer also includes a conventional processor 110, such as a Pentium® microprocessor manufactured by Intel, and conventional memory devices such as hard drive 108, floppy or CDRW drive(s) 112, and memory 114.

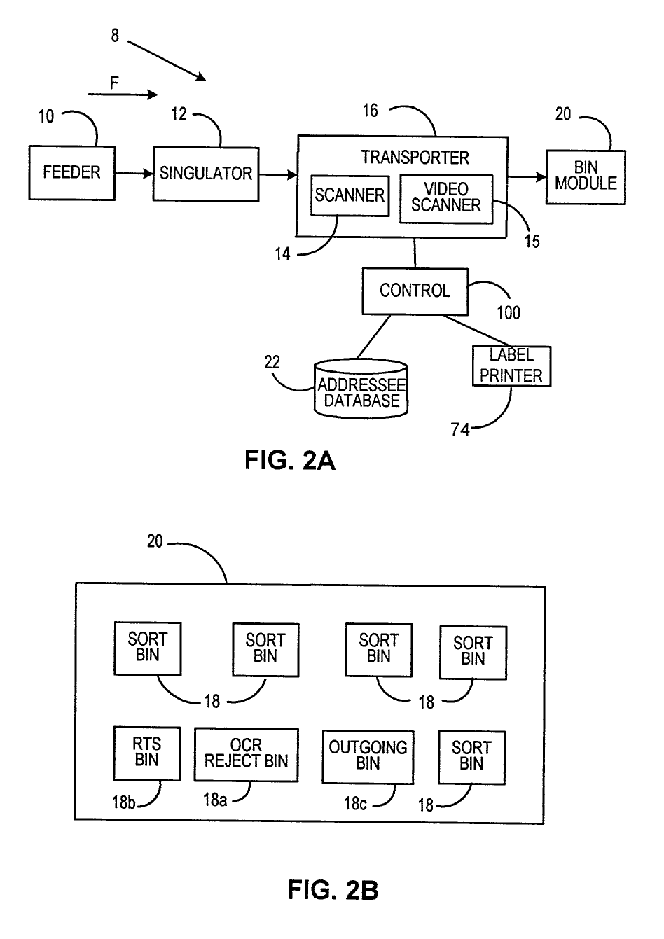

The computer system 100 can be connected to a sorting apparatus 8 as illustrated in FIG. 2a. The mailpiece sorting apparatus 8 may generally comprise a feeder 10, a line scan camera 14 (and optical character recognition (OCR) software, not shown), a video scanner 15, a mailpiece transporter 16, a bin module 20 (shown in FIG. 2b) with compartments or bins 18 (sort bin), 18a (OCR reject bin), 18b (RTS bin), 18c (outgoing bin) for receiving sorted mailpieces 30 and a control system 24 which may be the microprocessor based personal computer system 100 described above. The computer system 100 includes appropriate memory devices 108, 114 for storage of information such as an address database 22. One of ordinary skill in the art would be familiar with the general components of the sorting apparatus with which the system and method of the present invention may be implemented.

The mailpiece sorting apparatus 8 and the OCR software may be used to determine the addressee of the mailpiece 30 or other information such as return to sender graphics printed on the face of the mailpiece 30. The reading of various information may be performed with the assistance of intelligent character recognition (ICR) or imaging and optical character recognition (OCR/IC), which may be part of the above-mentioned OCR software and can read the various fields on the mailpiece 30.

Address Cleansing Database

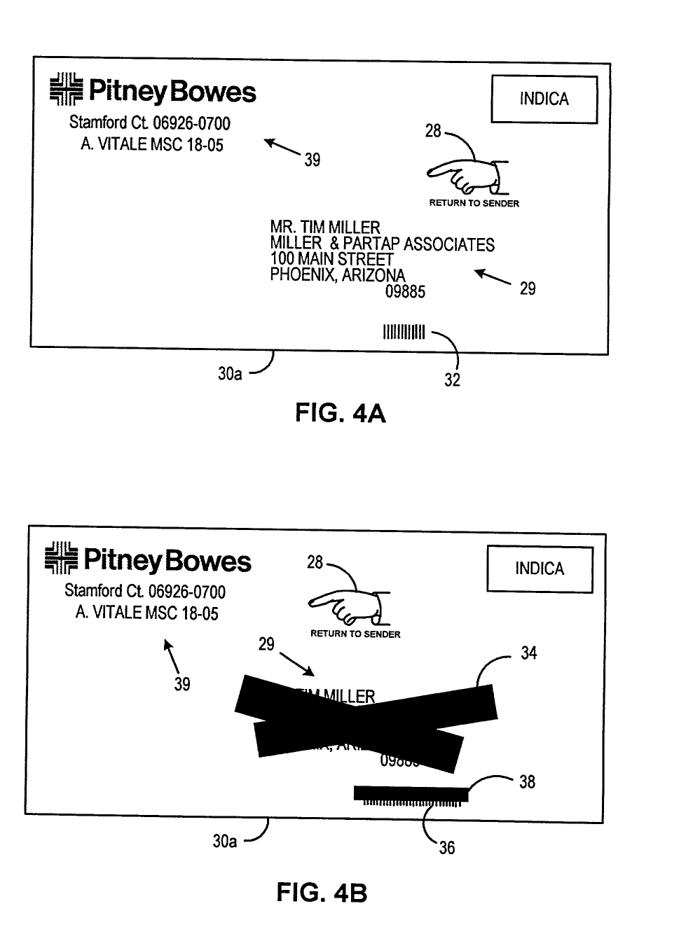

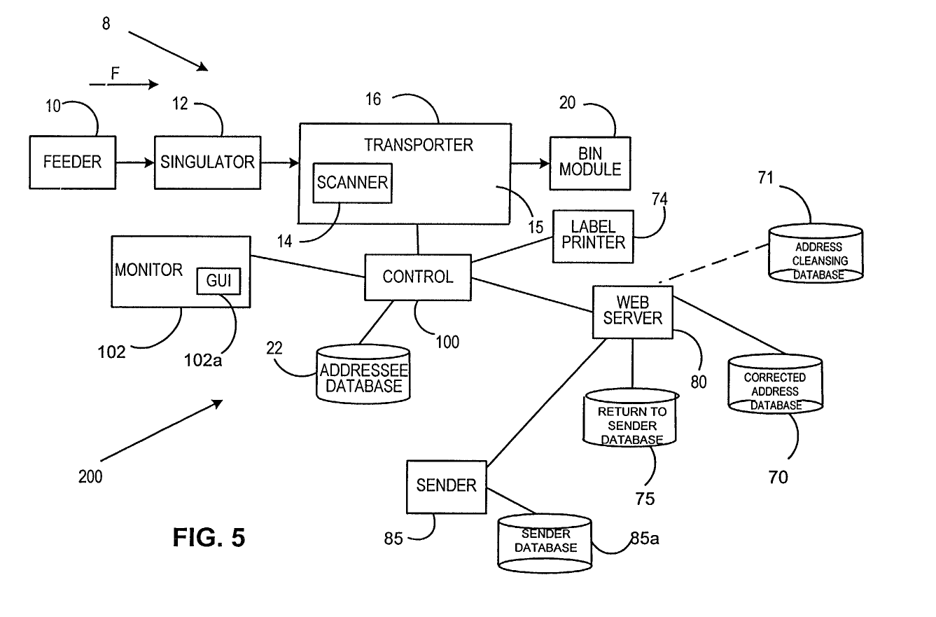

The mail sorting apparatus 8 of the present invention may be part of an interconnected system 200 (shown in FIG. 5) that includes an address-cleansing database. The system 200 can help companies reduce the amount of return to sender mail that is created by sender(s) (i.e. employees, divisions, and business units of the company). The address-cleansing database performs address cleansing of addressee information (correction and verification or indication of incorrect/uncorrectable address). Address cleansing can be done for address information from returned mailpieces 30a (shown in FIGS. 4a and 4b). The system 200 uses a matching program (not shown) and a database 71 to verify and correct addressee data obtained by the mailpiece sorting apparatus 8. The database 71 used with the system 200 can be a large, commercially available accurate consumer database located remotely from mailpiece sorting apparatus 8 as indicated by dashed lines in FIG. 5. One such database features more than 10 billion records furnished by more than 60,000 suppliers of information and cover a staggering 95 percent of U.S. households. This database functions independently of the NCOA and Postal databases and offers accurate and current data.

The computer system 100 of the mailpiece sorting apparatus 8 has a monitor 102 (which can display a graphical user interface 102a (GUI) to provide an operator with a helpful interface to request functions such as query an address, create a new mailing label, update a database or run a report), operator input device (i.e. mouse 106, keyboard 104) for permitting an operator to communicate requests or commands to the microprocessor 110 to which the microprocessor is programmed to be responsive. In addition, the personal computer 100 preferably includes one or more conventional data storage devices for storage of addressee data (corrected address database 70) for use in sorting incoming mailpieces.

Further, the system 200 includes label printer 74, which may be a type of commercially available printer, connected in serial or parallel communication with the microprocessor 110, and thus to the computer 100, for control thereby. The processor 110, and computer 100, includes the programs and routines hereinafter discussed for causing the computer 100 to implement the processing steps according to the invention.

The system 200 can perform identification and correction of addressee information such as, for example, names, personal titles, address information and customer move data, and verify life status. The system 200 could also verify and append atypical names including nicknames, hyphenated last names and personal name suffixes such as DDS, MD and Jr. Additional functionality can also include validation and correction of conventional street addresses including Post Office boxes and rural routes, and transposed street addresses.

The system 200 can be used in a standalone local access configuration with one graphical user interface 102a or workstation for an individual user, or it can be set up for multiple operators to receive customer information via a LAN-based mainframe or channel attachment. The system 200 can also be used Web-based (http) server or direct TCP/IP connectivity.

The system 200 of the present invention helps to reduce returned mail volume, lower returned mail expenses and rework costs. It also helps to maximize mail deliverability, reduce costs associated with paper, envelopes, printing, postage and labor. It can also help to increase efficiency and productivity in mailing operations. The system 200 as implemented in the present invention can help a company reduce the amount of potential return to sender mailpieces that are created in future mailpiece preparation by providing corrected address information for future mailings.

Reject Mailpieces

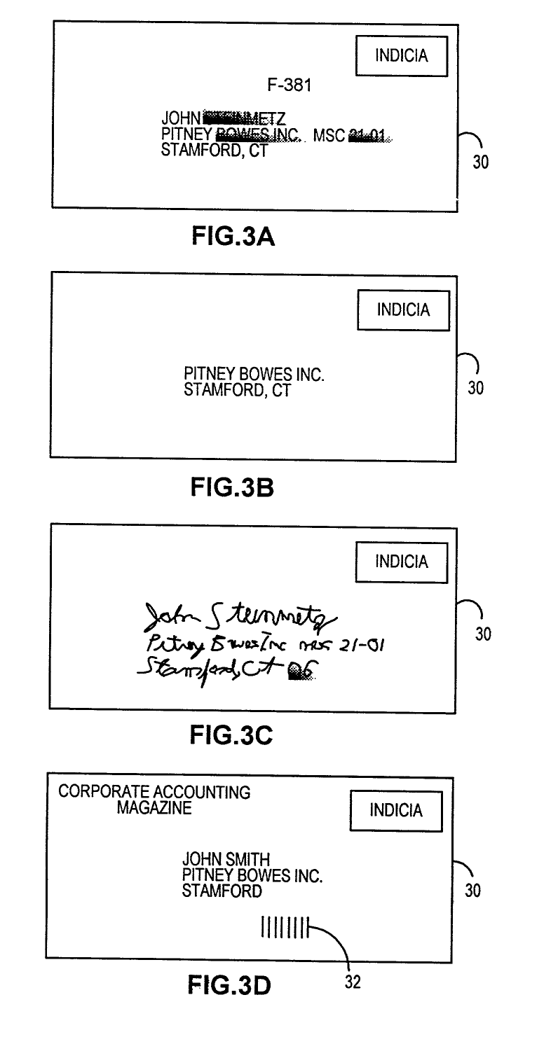

FIGS. 3a-3d illustrate various reject mailpieces 30. FIG. 3a is an example of a reject mailpiece 30, which is unreadable by the OCR system of the mailpiece sorting apparatus 8 because the addressee information is smeared (OCR reject). In some instances, the addressee information can be smeared to the point where the operator would need to open the mailpiece 30 to determine the addressee. FIG. 3b is an example of a reject mailpiece 30 for which the intended individual addressee cannot be determined from the face of the mailpiece 30 because there is no individual addressee but rather a general address to the company, as in this example, Pitney Bowes Inc. (mystery mail). In the case of the mystery mail of FIG. 3b, the mailpiece 30 would need to be opened to determine the appropriate addressee. In another example, not shown, the mailpiece 30 could be addressed to a company and I or department and would need to be opened to determine the appropriate addressee.

FIG. 3c is an example of mystery mail for which the intended individual addressee cannot be determined using OCR because the handwriting in the addressee segment is unreadable by the OCR of the mailpiece sorting apparatus 8 (mystery mail). It should be noted that while some handwriting is readable by OCR systems, not all handwriting is automatically readable, especially handwriting where the character shapes are of poor quality and are poorly spaced such as, for example, some cursive writing as is illustrated on mailpiece 30 in FIG. 3c.

FIG. 3d is an example of a reject mailpiece 30 for which the operator can determine the appropriate addressee from the face of the mailpiece 30 (without opening the mailpiece 30) but for which the OCR system of the mailpiece sorting apparatus 8 could not determine the appropriate addressee (research mail). In the example of FIG. 3d, the addressee database 22 contains two addressees named John Smith. The operator may be able to determine the appropriate addressee by reading the return address information. For example John Smith in accounting might get a mailpiece with a return address of a corporate accounting magazine, whereas John Smith of legal might get a mailpiece with a return address of a corporate counsel society. Thus, the mailpiece of FIG. 3d would be routed to John Smith of accounting and such information would be input by the operator using the voice recognition system.

Return to Sender (RTS) Mailpieces

Some reject mailpieces may be return to sender (RTS) mailpieces. A mailpiece may be returned to the sender for a number of reasons, such as, 1) the addressee or intended recipient printed on the mailpiece 30 may not be accurate or complete enough for the post office (i.e. United States Postal Service (USPS)) to determine the intended destination; 2) the addressee or intended recipient may have moved and left no forwarding address; or 3) the addressee or intended recipient may have moved, left a forwarding address, but the time limit for the post office to forward their mailpieces may have expired.

The post office may mark the return to sender mailpiece as follows: 1) an image of a hand with a pointing finger and Return to Sender inscribed within or near the hand; 2) text may show the post office returning the piece and the reason why it was returned; 3) the post office may put on a label with return to sender text and additional text indicating why the piece was not deliverable; and/or 4) the post office may draw a line through the recipient address and/or its POSTNET bar code. These RTS markings or labels may obscure part or all of the original addressee or intended recipient.

FIG. 4a illustrates an exemplary return to sender mailpiece 30a. The mailpiece 30 includes an image 28 of a hand with a pointing finger and return to sender inscribed near the hand. The exemplary mailpiece of FIG. 4 shows the addressee or intended recipient 29: Mr. Tim Miller, Miller & Partap Associates, 100 Main Street, Phoenix, Ariz. 09885. In this example, the addressee or intended recipient has not been obscured by the USPS markings on the envelope. The return address or sender for the exemplary mailpiece is: Pitney Bowes, A. Vitale, MSC 18-05, Stamford, Conn. 06926-0700.

FIG. 4b illustrates an exemplary return to sender mailpiece 30a where the addressee information has been obscured. The mailpiece 30 includes an image 28 of a hand with a pointing finger and return to sender inscribed within the hand. The exemplary mailpiece of FIG. 4b shows the addressee or intended recipient 29: Mr. Tim Miller. In this example the addressee 29 (including ZIP Code and state) have has been obscured by the USPS markings 34 on the envelope. The POSTNET barcode 36 has also been obscured by markings 38. The return address or sender 39 for the exemplary mailpiece is: Pitney Bowes, A. Vitale, MSC 18-05, Stamford, Conn. 06926-0700. The present invention sorts return to sender mailpieces such as the envelope of FIG. 4b to the return to sender bin 18b (see FIG. 2b) using recognition by the OCR system of return to sender indicators or other methods as determined by one of ordinary skill in the art considering, for example, factors such as cost and accuracy.

System for Processing Return to Sender Mailpieces

An embodiment of the system of the present invention is illustrated in FIG. 5 and referred to generally as system 200 which comprises mailpiece sorting apparatus 8, address cleansing database 71, a return to sender database 75, sender 85, sender database 85a, corrected address database 70, software for performing address comparisons (not shown), label printer 74 and a web server 80 for interconnecting several components of the system 200. The system 200 provides a closed loop solution for reducing return to sender mailpieces generated by a sender 85 within a company that is sorting incoming mailpieces (using an incoming mail sorting apparatus 8) based upon information collected using the automated incoming mail sorting apparatus 8.

The interconnection and functionality of the system 200 can be understood generally as follows. The mail sorting apparatus 8 as described above, could read the addressee information using the OCR system or alternately, a video scanner 15 could capture an image of the mailpiece and an operator could review the image and input the address data into the system.

In the present embodiment, the operator inputs the addressee information from the RTS mailpiece using a GUI of the mailpiece sorting apparatus 8. However other methods such as, for example, video coding could be used. It should be noted that in this example, the operator is inputting the address as read and not making corrections to such addresses although alternately the operator could make corrections when inputting address information. The operator can indicate that the mailpiece is a return to sender mailpiece and request that the system 200 performs address cleansing of the input information. The transmission of such information can be facilitated using a web server 80. Transmission by other means could be determined by one of ordinary skill in the art. The web server 80 is connected to the mailpiece sorting apparatus 8 where the addressee information is obtained and, if possible, cleansed (also called address hygiene), meaning that the addressee information is corrected by comparing it to a database such as the commercially available database 71 or corrected address database 70. The correction process typically is performed using a comparison software package and a comprehensive address database 71. The system 200 can provide results such as, for example, a corrected address or a message that a corrected address is not available. The correct address can be saved in database 70 so that future RTS mailpieces can be corrected using the data in database 70 as opposed to database 71, which can have a cost, associated with each address cleansing each transaction.

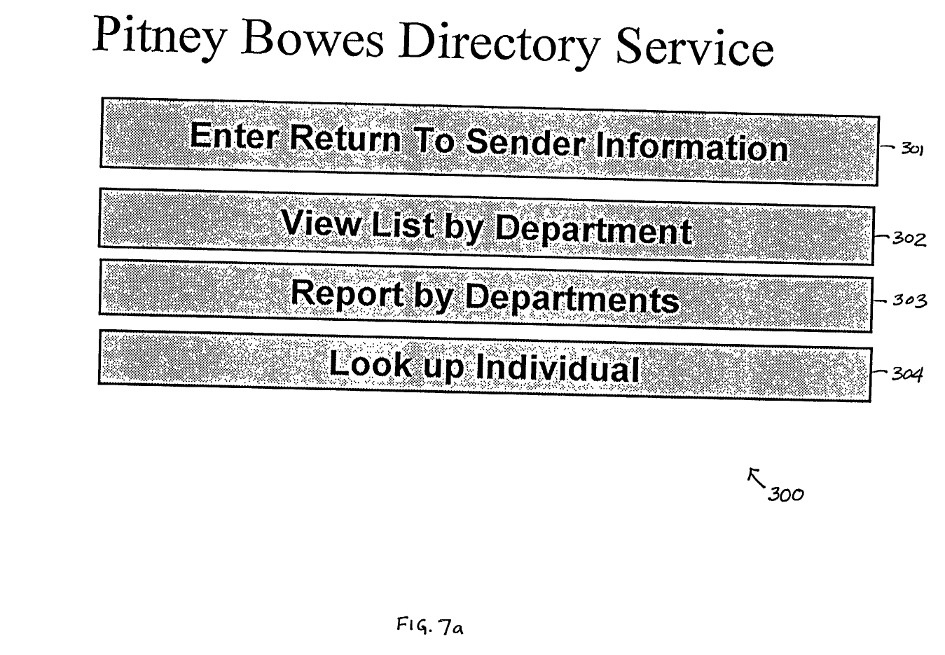

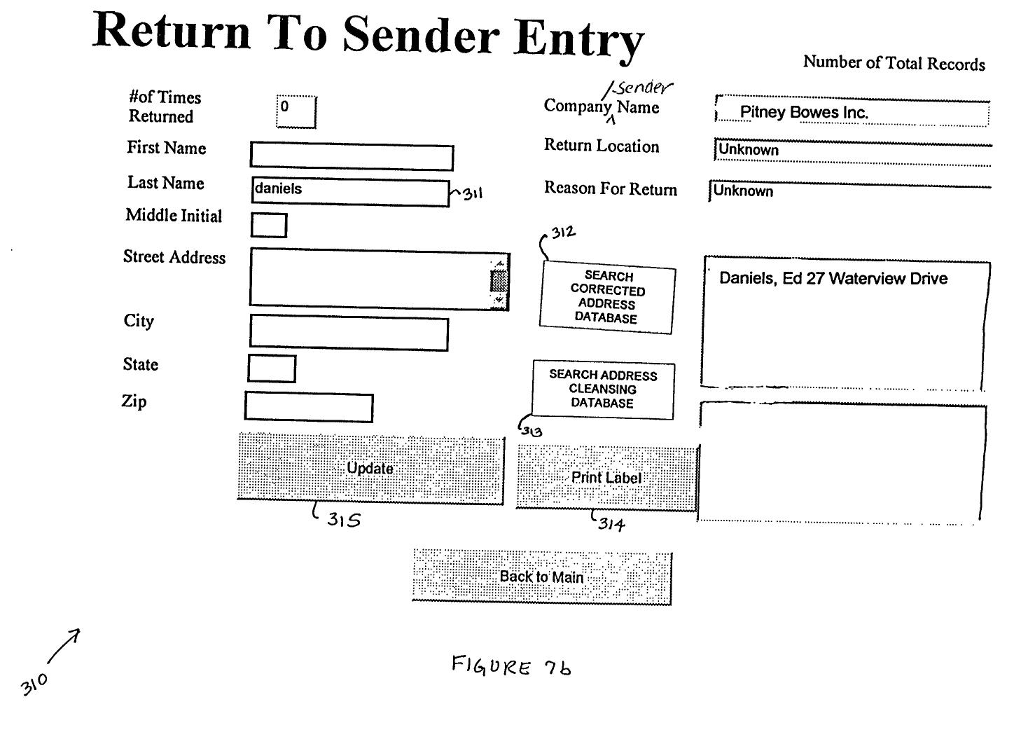

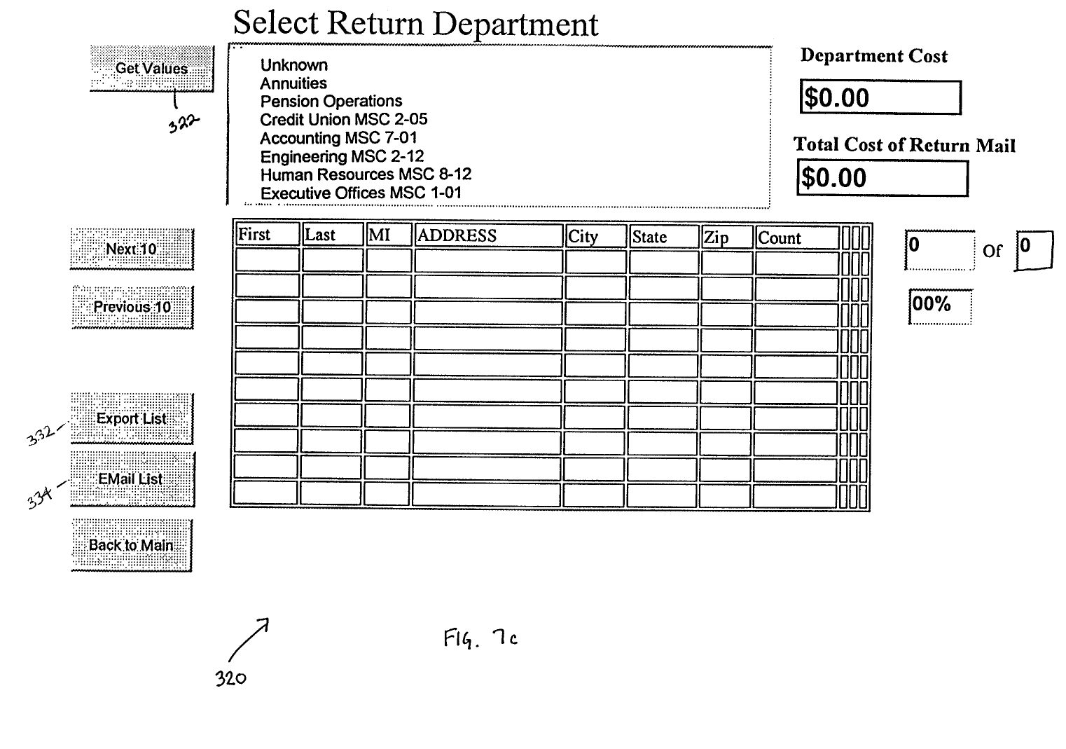

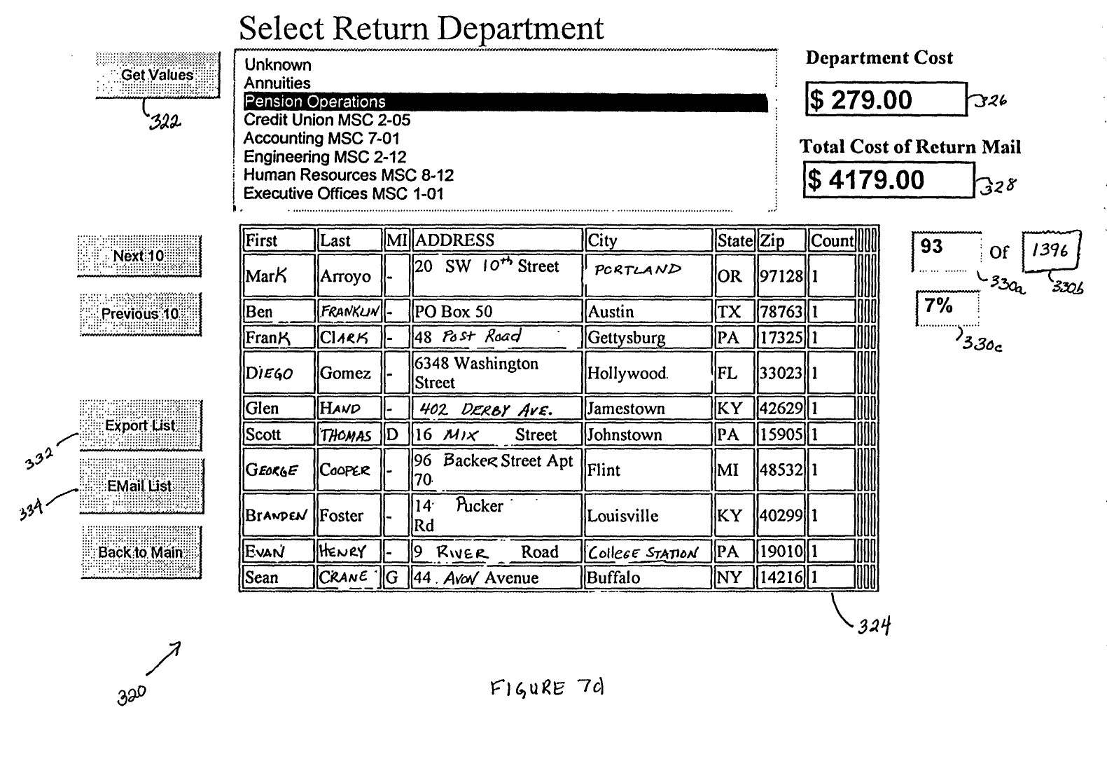

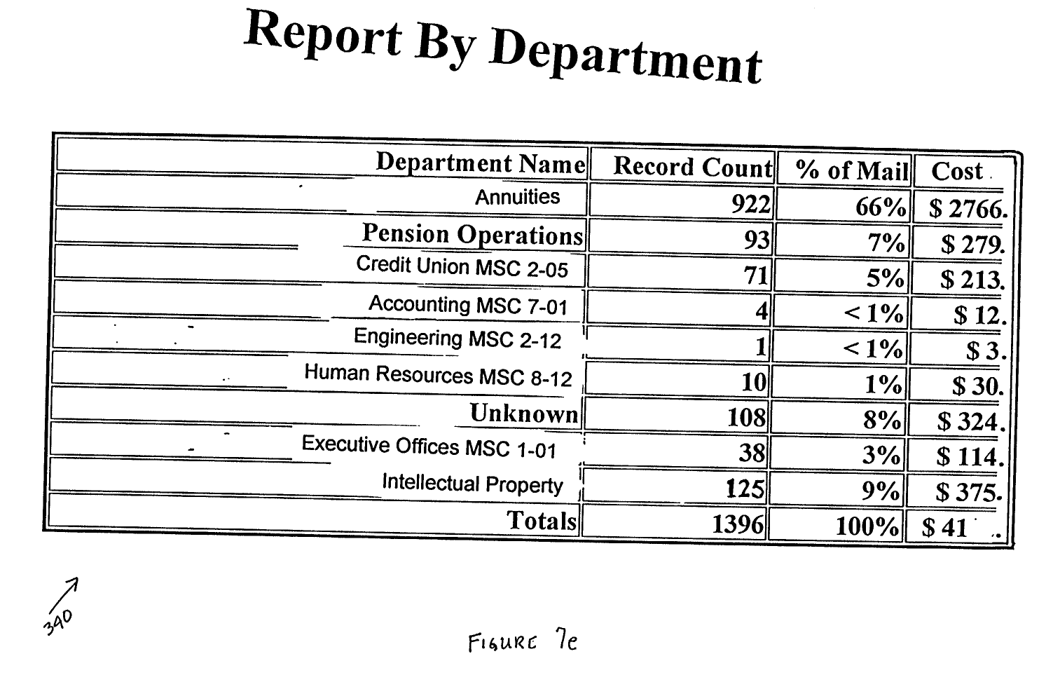

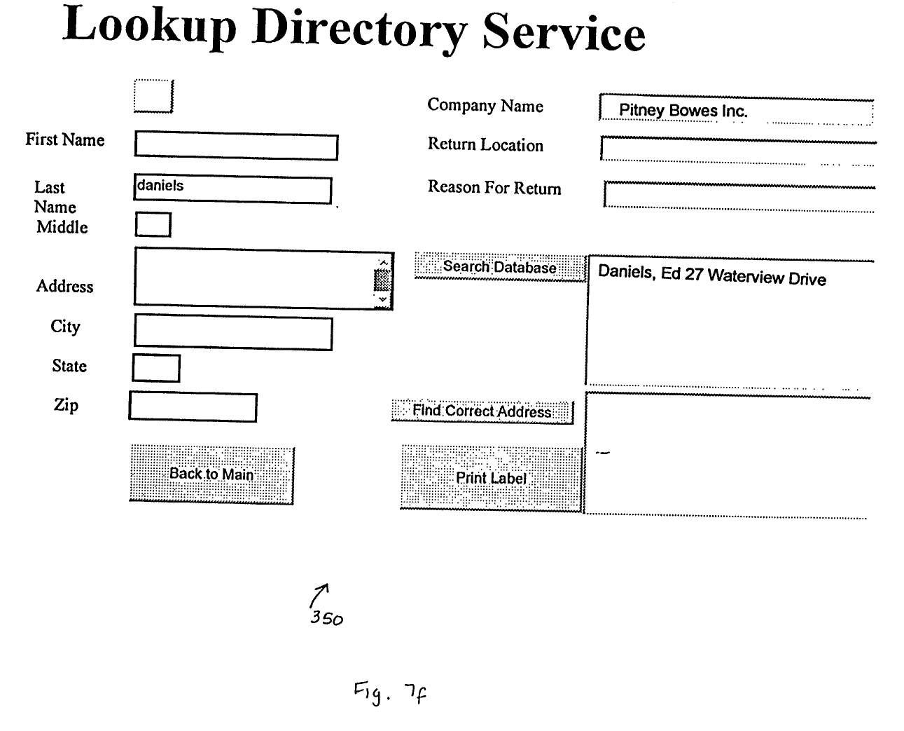

The resulting information can indicate for example that a correct address is not available (and thus the mailpiece is undeliverable) or can provide the corrected or cleansed address to the database 70 through server 80 which also connects the address cleansing database 71 with the mailpiece sorting apparatus 8. The corrected address database 70 stores the correct information in association with the incorrect address information obtained by the mailpiece sorting apparatus 8. This association will be described in more detail below in the description of the reports and input screens of FIGS. 7a-f.

Method for Processing Return to Sender Mailpieces

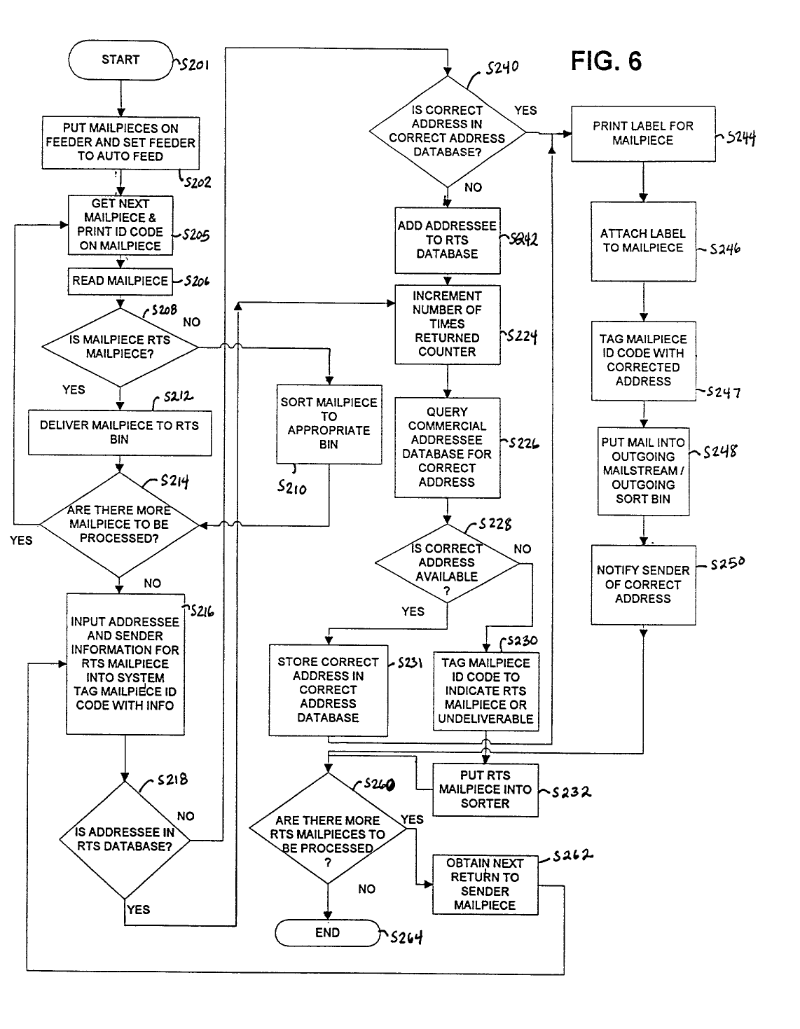

FIG. 6 illustrates an embodiment of the method of the present invention for processing return to sender mailpiece(s). An embodiment of a method of the present invention may be performed using the system 200 illustrated in FIG. 5. Turning to FIGS. 6, at step S201 the method begins. At step S202 a stack of incoming mailpieces (not shown) is placed on the feeder 10 of the mailpiece sorting apparatus 8 and the feeder 10 is set to auto feed and mailpiece begin to be fed along feed path F of the mailpiece sorting apparatus 8. At step S205 an identification (ID) code 32 (shown in FIG. 4a) is printed on the mailpiece. At step S206 the mailpieces 30 are read using the OCR system. Next at step S208 a query is made as to whether the mailpiece is a return to sender mailpiece.

The determination as to whether a mailpiece is a return to sender mailpiece may be made using various methods as determined by one of ordinary skill in the art considering, for example, cost factors. Typical return to sender mailpieces are marked with return to sender text and/or a graphics symbol or the addressee information is obscured. An OCR system would need the capability to read particular regions of the mailpiece (read regions) to recognize return to sender icon or markings. Other methods can be determined by one of ordinary skill in the art to determine whether a mailpiece is a return to sender mailpiece.

Returning to the query of step S208, if the answer to the query S208 is no, then the mailpiece 30 is delivered to an appropriate sort bin 18 at step S210. If the answer to the query S208 is yes, then the mailpiece 30 is delivered to the return to sender sort bin 18b at step S212.

Following steps S210 and S212, a query is made at step S214 as to whether there are additional mailpieces 30 to be processed. If the answer to the query of step S214 is yes, then steps S205 through S212 are performed until no mailpieces 30 are left to be processed. If the answer to the query of step S214 is no, then the method proceeds to step S216 where addressee and sender information for the RTS mailpiece 30a is input into the system 200 (if such information is available/readable from the mailpiece and tagged to mailpiece ID code 32). In the present embodiment, the information is manually input into the system 200; however, automated input or partially automated input such as through the use of voice recognition could be implemented. Next at step S218 a query is made as to whether the address information is in the RTS database 75. If the answer to the query of step S218 is yes, then at step S224 a return to sender counter (not shown), which counts the number of times a return to sender mailpiece(s) for a particular addressee and sender are returned, is incremented. Next at step S226 a commercially available address-cleansing database 71 (shown in FIG. 5) is queried to a correct address.

At step 228, a query is made as to whether the addressee can be corrected or cleansed using the address-cleansing database 71. If the answer to the query of step S228 is no, then at step S230 the mailpiece ID code 32 for the return to sender mailpiece 30a is tagged to indicate that the mailpiece is undeliverable or that the mailpiece should be returned to sender if the sender information was input in step S216. Next at step S232 the mailpiece is placed on the mailpiece sorting apparatus 8 and sorted to appropriate bins by reading the ID code 32 and using the information tagged to the ID code to determine the appropriate bin (i.e. reject bin 18b or appropriate sort bin 18 for delivery to sender).

Returning to the query of step S228, if the answer to the query of step S228 is yes, then at step S231 then the correct address is stored in corrected address database 70. Next at step S244 a label containing the correct address can be printed (using label printer 74 shown in FIG. 5) for the mailpiece and at step S246 the label can be attached to the mailpiece 30a. The label printer 74 can be located in the area of the physical location of the mailpiece. At step S247 the mailpiece ID code is tagged with the corrected address. At step S248 mailpieces are put into outgoing mail stream/sorted to outgoing sort bin 18c using mailpiece sorting apparatus 8. Next at step S250 the sender can be notified of the correct address. This can be performed via email or other suitable method. Next the query of step S260 made to determine whether there are more RTS 30a mailpieces to be processed.

Returning to the query of step S218, if the answer to the query of step S218 is no, then at step S240 a query is made as to whether the correct address is in the corrected address is in the corrected address database 70. Previously corrected addresses are stored in the corrected address database 71 (see step S231) so that transactional costs of querying address cleansing database 71 can be minimized by first querying the corrected address database 70. If the answer to the query of step S240 is no, then at step S242 the addressee is added to the RTS database 75 which contains addresses that are not corrected/correctable. Next at step S224 the return to sender counter (not shown), which counts the number of times a return to sender mailpiece(s) for a particular addressee and sender are returned, is incremented. Next at step S226 a commercially available address-cleansing database 71 (shown in FIG. 5) is queried to a correct address. At step 228, a query is made as to whether the addressee can be corrected or cleansed using the address-cleansing database 71. If the answer to the query of step S228 is no, then at step S230 the mailpiece ID code 32 for the return to sender mailpiece 30a is tagged to indicate that the mailpiece is undeliverable or that the mailpiece should be returned to sender if the sender information was input in step S216. Next at step S232 the mailpiece is placed on the mailpiece sorting apparatus and resorted to appropriate bins by reading the ID code 32 and using the information tagged to the ID code to determine the appropriate bin (i.e. reject bin 18b or appropriate sort bin 18 for delivery to sender). If the answer to the query of step S228 is yes, then at step S231 then the correct address is stored in corrected address database 70. Next at step S244 a label containing the correct address can be printed (using label printer 74 shown in FIG. 5) for the mailpiece and at step S246 the label can be attached to the mailpiece 30a. The label printer 74 can be located in the area of the physical location of the mailpiece. At step S247 the mailpiece ID code is tagged with the corrected address. At step S248 mailpieces are put into outgoing mail stream/sorted to outgoing sort bin 18c using mailpiece sorting apparatus 8. Next at step S250 the sender can be notified of the correct address. This can be performed via email or other suitable method. Next the query of step S260 is made to determine whether there are more RTS 30a mailpieces to be processed.

The steps following step S218, as appropriate, are repeated until there are no RTS mailpieces left to be processed, in which case, the method ends at step S264.

Returning to the query of step S240, if the answer to the query of step S240 is no, then at step S244 a label containing the correct address can be printed (using label printer 74 shown in FIG. 5) for the mailpiece and at step S246 the label can be attached to the mailpiece 30a. The label printer 74 can be located in the area of the physical location of the mailpiece. At step S247 the mailpiece ID code is tagged with the correct address. At step S248 the mailpiece is put into outgoing mailstream/sorted to outgoing sort bin 18c (placed on the mailpiece sorting apparatus and resorted to appropriate bins by reading the ID code 32 and using the information tagged to the ID code to determine the appropriate bin). Next at step S250 the sender can be notified of the correct address or notification of an incorrect address, as the case may be, is sent to the sender 85 of the mailpiece (preferably via email although other suitable methods may be used) and/or to the sender's database 85a for action such as correction, notation or deletion of the address record. This is done to prevent future mailings to the same addressee and thus reduce future return to sender mailpieces 30a generated by the sender.

Next the query of step S260 is made to determine whether there are more RTS 30a mailpieces to be processed. If the answer to the query of step S260 is yes, then at step S262 the next RTS mailpiece 30a is obtained and the steps following step S216 are repeated, as appropriate, until there are no RTS mailpieces left to be processed, in which case, the method end at step S264.

Graphical User Interface/Reports/Data Input

FIGS. 7a-f illustrate embodiments of user screens from the graphical user interface of the system of the present invention including data input screens and report screens. Because of the significant expense in processing such return to sender mailpieces (it has been estimated that 3% to 7% of incoming mail that a company sends out with an incorrect address is returned to sender and the cost of processing an individual return to sender mailpiece in an incoming mailstream is estimated to be approximately $3 to $8) the system of the present invention tracks and calculate statistical information and cost information regarding the return to sender mailpieces so that the sender can be charged for the cost of sorting return to sender mailpieces.

FIG. 7a is an embodiment of an initial window or page (the Pitney Bowes Directory Service page) 300 that an operator can use when using the graphical user interface 70a of system 200 to input information or run reports or perform other functions as provided. The Enter Return to Sender Information icon 301 can be executed (i.e. by clicking a mouse operated pointer on the icon); this will launch the Return to Sender Entry page 310 (illustrated in FIG. 7b). The Return To Sender Entry page 310 can be used to input addressee information. As an example, the page of FIG. 7b has the name Daniels input into the last name field 311, after which the search correct database 70 icon 312 is executed to attempt to obtain the correct address from corrected address database 70. If no address is available from corrected address database 70, the search address-cleansing database 71 icon 313 can be executed to attempt to obtain the correct address from the address-cleansing database 71. If by executing either icon 312 or 313, the correct address is found, then icon 314 may be executed to print a label for the mailpiece using label printer 74 (shown in FIG. 5).

Additionally, after executing a search using the address cleansing database 71, if a correct address is found, the correct address database 70 may be updated (corrected address saved to database) using the update icon 315. Additional information such as, for example, first name, middle initial, city, state, zip code, return location and reason for return may be entered at this screen. The update icon will also increment the number of times returned window to indicate the number of times mailpieces addressed to an addressee have been returned.

FIG. 7c illustrates the input page Select Return Department 320 is used to select a department for which to run a report; this screen can be launched by executing the View List by Department icon 302 of the Pitney Bowes Directory Service screen 300. Once the return department is selected, the get values icon 322 can be executed. FIG. 7d is an exemplary window illustrating the result after the pension operations department is selected and the get values icon 322 is executed. Box 324 displays the sender's names and address information for the related department Pension Operations, as well as the number of return to sender mailpieces 30a associated with each sender from Pension Operations. Box 325 displays the $329. cost of the return to sender mailpieces to the Pension Operations department. Box 328 displays the $4179. cost of the return to sender mailpieces for all departments sorted using a particular sort plan (for sorting incoming mailpieces) that produced these results. Box 330a illustrates the number of return to sender mailpieces attributed to the Pension Operations department using the particular sort plan to sort incoming mailpieces. Box 330b illustrates the number of incoming mailpieces sorted using the sort plan. Box 330c illustrates the percentage of return to sender mailpieces for the Pension Operations department based upon the total number of incoming mailpieces sorted by the sort plan. Icon 332 can be used to export the return to sender information to the sender's database and/or icon 334 can be used to deliver return to sender information to the sender via email.

FIG. 7e illustrates the report page 340 that is generated by executing the Report by Departments icon 303 of the Pitney Bowes Directory Service screen 300. The report includes, for example, department name, number of mailpieces or record count sorted for the department. The percentage of mailpieces sorted for the department as compared to the total number of incoming mailpieces sorted and the cost of the sort to the department.

FIG. 7f illustrates the look up directory service screen 350, which is generated by executing the Look Up Individual icon 304 of the Pitney Bowes Directory Service screen 300. This screen can be accessed by a sender 85 who is looking for corrected address information prior to sending a mialpiece. The sender can access such information by connection to the corrected address database 71 or address cleansing database 70 via a web server 80 or other suitable interconnection.

The embodiments described herein can provide the advantages of lowering the costs of processing return to sender mailpieces by creating a system with the capability of conveying information regarding return to sender mailpieces so that such information can be used in incoming mailpiece processing and future outgoing mailpiece processing such as updating senders databases and informing senders of changed addresses. By implementing the present invention, companies handling very large numbers of incoming mailpieces can save thousands of dollars per year by implementing the method and apparatus of the present invention. While the present invention has been disclosed and described with reference to a various embodiments thereof, it will be apparent, as noted above that variations and modifications may be made therein. It is, thus, intended in the following claims to cover each variation and modification that falls within the true spirit and scope of the present invention.

What is claimed is:

1. A system for sorting incoming mailpieces and processing address changes comprising:
a mailpiece sorting apparatus for sorting incoming mailpieces and determining whether a mailpiece is a return to sender mailpiece by reading information from the mailpiece;
an input station for inputting information for an addressee and a sender of the return to sender mailpiece, the input station operatively coupled to the mailpiece sorting apparatus and configured to update addressee information for the addressee of the return to sender mailpiece;
an address cleansing database operatively coupled to the mailpiece sorting apparatus for providing updated address information for the addressee of the return to sender mailpiece; and
a corrected address database for storing updated address information for the addressee of the return to sender mailpiece, the corrected address information database for providing corrected address information for the addressee of subsequent return to sender mailpieces prior to requesting updated addressee information from the address cleansing database.

2. The apparatus as claimed in claim 1 further comprising:
a web server for operatively coupling the address cleansing database and the corrected address database to the mailpiece sorting apparatus.

3. The apparatus as claimed in claim 1 further comprising:
a return to sender database for storing addressee information that was input from the return to sender mailpiece at the input station, the addressee information stored in association with sender information that was input from the mailpiece at the input station.

4. The apparatus as claimed in claim 3 further comprising:
a counter, the counter increments each time the addressee of the return to sender mailpiece is input at the input station, the increment is stored in association with the sender of the mailpiece, whereby if more than one sender receives return to sender mailpieces for a same addressee a separate count is stored for each sender.

5. The apparatus as claimed in claim 4 further comprising:
a graphical user interface displayed at the input station of the mailpiece sorting apparatus, the graphical user interface comprising addressee and sender input fields, a search corrected address databases icon and a search address cleansing database icon.

6. The apparatus as claimed in claim 1 further comprising:
a label printer operatively coupled to the mailpiece sorting apparatus, the label printer for printing a label with addressee information obtained from the corrected address database or the address cleansing database, the label for placing on the return to sender mailpiece to assist in subsequent delivery of the mailpiece to an addressee contained in the addressee information printed on the label.

7. The apparatus as claimed in claim 1 further comprising:
a sender database operatively coupled to the mailpiece sorting apparatus, the sender database for receiving updated addressee information, whereby a sender can use the updated addressee information on subsequent mailpieces sent to the addressee.

8. A method of processing incoming mailpieces and address changes, the method comprising the steps of:
a. sorting incoming mailpieces with a mailpiece sorting apparatus and determining whether a mailpiece is a return to sender mailpiece by reading information from the mailpiece;
b. inputting information for an addressee and a sender of the return to sender mailpiece at an input station, the input station operatively coupled to the mailpiece sorting apparatus;
c. requesting updated address information for the addressee of the return to sender mailpiece from a corrected address database; and
d. requesting updated address information for the addressee of the return to sender mailpiece from the address-cleansing database if updated address information is not available from the corrected address database.

9. The method as claimed in claim 8 further comprising the step of:
e. storing address information that was input for the addressee and the sender of the return to sender mailpiece at the input station, the address information for the addressee stored in association with the sender.

10. The method as claimed in claim 9 further comprising the step of:
f. incrementing a counter each time the addressee of the return to sender mailpiece is input at the input station, the increment is stored in association with the sender of the mailpiece.

11. The method as claimed in claim 8 further comprising the step of:
e. printing a label with addressee information obtained from the corrected address database or the address cleansing database and placing the label on the return to sender mailpiece to assist in subsequent delivery of the mailpiece to an addressee contained in the addressee information printed on the label.

12. The method as claimed in claim 11 further comprising the step of:
f. calculating a cost of processing the return to sender mailpiece using the increment stored in association with the sender of the mailpiece and a cost per mailpiece.

13. The method as claimed in claim 8 further comprising the step of:
e. updating a sender database with updated addressee information, whereby a sender can use the updated addressee information on subsequent mailpieces sent to the addressee.

14. A method of processing incoming mailpieces and address changes, the method comprising the steps of:
a. sorting incoming mailpieces with a mailpiece sorting apparatus and determining whether a mailpiece is a return to sender mailpiece by reading information from the mailpiece;
b. inputting information for an addressee and a sender of the return to sender mailpiece at an input station, the input station operatively coupled to the mailpiece sorting apparatus;
c. requesting updated address information for the addressee of the return to sender mailpiece from a corrected address database;
d. requesting updated address information for the addressee of the return to sender mailpiece from the address-cleansing database if updated address information is not available from the corrected address database;
e. storing address information that was input for the addressee and the sender of the return to sender mailpiece at the input station, the address information for the addressee stored in association with the sender;
f. incrementing a counter each time the addressee of the return to sender mailpiece is input at the input station, the increment is stored in association with the sender of the mailpiece;
g. printing a label with addressee information obtained from the corrected address database or the address cleansing database and placing the label on the return to sender mailpiece to assist in subsequent delivery of the mailpiece to an addressee contained in the addressee information printed on the label;
h. calculating a cost of processing the return to sender mailpiece using the increment stored in association with the sender of the mailpiece and a cost per mailpiece; and
i. updating a sender database with updated addressee information, whereby a sender can use the updated addressee information on subsequent mailpieces sent to the addressee.
